(19) United States
(12) Patent Application Publication
(10) Pub. No.: US 2024/0173734 A1
(43) Pub. Date: May 30, 2024

(54) AUTOMATIC SPRAY APPARATUS COMPRISING AIRBRUSH AND MASK TRANSFER MECHANISM

(71) Applicant: KOREA INSTITUTE OF OCEAN SCIENCE & TECHNOLOGY, Busan (KR)

(72) Inventors: Chi-Yeong AHN, Daejeon (KR); Hyungwon SHIM, Sejong (KR); Hyun Suk KIM, Sejong (KR); Young-Shik KIM, Daejeon (KR)

(73) Assignee: KOREA INSTITUTE OF OCEAN SCIENCE & TECHNOLOGY, Busan (KR)

(21) Appl. No.: 18/434,277

(22) Filed: Feb. 6, 2024

Related U.S. Application Data
(63) Continuation of application No. PCT/KR2022/011296, filed on Aug. 1, 2022.

(30) Foreign Application Priority Data
Aug. 23, 2021 (KR) 10-2021-0111178

(51) Int. Cl. B05B 12/22; B05B 7/04; B05B 15/68

(52) U.S. Cl. CPC B05B 12/22; B05B 7/0416; B05B 15/68

(57) ABSTRACT

Proposed is an automatic spray apparatus including an airbrush and mask transfer mechanism, the apparatus including an airbrush for spraying liquid through a nozzle by using air supplied thereto, an airbrush transfer unit capable of adjusting a relative distance from the airbrush to a liquid spray target while supporting the airbrush, a mask having a hole formed in a shape in which the liquid is applied on a surface of the liquid spray target, and a mask transfer unit installed between the nozzle of the airbrush and the liquid spray target while supporting the mask, wherein the airbrush transfer unit includes a trigger actuator capable of operating a trigger that controls the spraying of the liquid contained in a part of the airbrush. The automatic spray apparatus can be implemented at a relatively low cost to be used when manufacturing an MEA having a small area.

### CROSS-REFERENCE TO RELATED APPLICATIONS

This application is a continuation of International Application No. PCT/KR2022/011296 filed on Aug. 1, 2022, which claims priority to Korean Patent Application No. 10-2021-0111178 filed on Aug. 23, 2021, the entire contents of which are herein incorporated by reference.

### TECHNICAL FIELD

The present disclosure relates to an automatic spray apparatus, and, more particularly, to an automatic spray apparatus including an airbrush and mask transfer mechanism.

### BACKGROUND ART

In order to manufacture a membrane electrode assembly (MEA) for application to an electrochemical energy conversion device such as fuel cells or water electrolysis cells, a process of coating a functional membrane (Nafion® membrane, etc.) with a nano-sized electrode material is required, and a spray method and a decal transfer method are mainly used to coat the membrane with a nano-sized electrode material.

In this case, the spray method using an airbrush is suitable for manufacturing an MEA having a small area, and the decal transfer method is suitable for manufacturing an MEA a large area.

Since the amount of fuel cell or water electrolysis catalyst synthesized in a laboratory is very small in the range of several to tens of mg, it is preferable to manufacture an MEA by the spray method using an airbrush.

The process of manufacturing such a small-area MEA goes through the following steps.
1. Ink is made by dispersing nano-sized catalysts in an alcohol-type solvent.
2. The prepared catalyst ink is put into a paint container of the airbrush and the lid of the paint container is closed.
3. Spray of the ink is performed until coating of the appropriate amount of the ink is performed (anode and cathode at front and back). (As the catalyst ink is sprayed, the solvent vaporizes and a membrane is coated with only the electrode material.)
4. After manufacturing an MEA, a mask such as acrylic is removed to be applied to an electrochemical energy conversion device.

When manufacturing a small-area MEA in a laboratory and a school, etc., the above process is performed. An automatic spray machine currently in circulation for performing the process is difficult to be used in a laboratory due to reasons such as a cost, an area occupied by the machine, and maintenance.

In order to solve the problem described above, an

automatic spray apparatus including an airbrush and mask transfer mechanism that can be used when manufacturing an MEA having a small area is intended to be provided.

### DOCUMENTS OF RELATED ART

### Patent Documents

(Patent Document 1) Japan Patent No. 3342165 (Title: Pattern coating method, registration date: Aug. 23, 2002)

(Patent Document 2) U.S. Pat. No. 5,562,766 (Title: Method and composition for paint masking, registration date: Oct. 8, 1996)

### DISCLOSURE

### Technical Problem

The present disclosure has been made to solve the above problems, and is intended to propose an automatic spray apparatus including an airbrush and mask transfer mechanism, in which the automatic spray apparatus can be implemented at a relatively low cost so that the apparatus can be used in manufacturing a membrane electrode assembly (MEA) having a small area for application to an electrochemical energy conversion device.

The technical objective of the present disclosure is not limited to the objective mentioned above, and other technical objectives not mentioned will be clearly understood by those skilled in the art from the description below.

### Technical Solution

An automatic spray apparatus including an airbrush and mask transfer mechanism according to an exemplary embodiment of the present disclosure devised in order to accomplish the above objectives includes: an airbrush for spraying liquid through a nozzle by using air supplied thereto; an airbrush transfer unit capable of adjusting a relative distance from the airbrush to a liquid spray target while supporting the airbrush; a mask having a hole formed in a shape in which the liquid is applied on a surface of the liquid spray target; and a mask transfer unit installed between the nozzle of the airbrush and the liquid spray target while supporting the mask, wherein the airbrush transfer unit comprises a trigger actuator capable of operating a trigger that controls the spraying of the liquid contained in a part of the airbrush.

In addition, the airbrush transfer unit of the automatic spray apparatus including an airbrush and mask transfer mechanism according to the exemplary embodiment of the present disclosure may include a driving device such as a motor that enables a position of the airbrush to be adjusted up, down, left, right, forward, and rearward.

In addition, the mask transfer unit of the automatic spray apparatus including an airbrush and mask transfer mechanism according to the exemplary embodiment of the present disclosure may include a driving device such as a motor that enables a position of the mask to be adjusted up, down, left, right, forward, and rearward.

In addition, the spray apparatus of the automatic spray apparatus including an airbrush and mask transfer mechanism according to the exemplary embodiment of the present disclosure may include a user interface device that is capable of being directly manipulated by a user, wherein the user is capable of inputting a trajectory and a speed at which the airbrush transfer unit or the mask transfer unit is desired to be moved by manipulating a specific part on a surface of the user interface device, and the user interface device transmits the input of the user to a control unit that controls the airbrush transfer unit and the mask transfer unit so that the airbrush transfer unit or the mask transfer unit is moved at the desired trajectory and speed through the control unit.

### Advantageous Effects

According to an embodiment of the present disclosure, it is possible to provide the automatic spray apparatus including an airbrush and mask transfer mechanism, in which the automatic spray apparatus can be implemented at a relatively low cost so that the apparatus can be used in manufacturing a membrane electrode assembly (MEA) having a small area for application to an electrochemical energy conversion device.

The effects of the present disclosure are not limited to the effects mentioned above, and other effects not mentioned may be clearly understood by those skilled in the art from the description of the claims.

### DESCRIPTION OF DRAWINGS

FIG. 1 is a side view generally illustrating how ink is sprayed by using an automatic spray apparatus including an airbrush and mask transfer mechanism according to an embodiment of the present disclosure.

FIG. 2 is a conceptual diagram illustrating a case of moving an airbrush diagonally by using an airbrush transfer unit while the airbrush of the automatic spray apparatus including an airbrush and mask transfer mechanism according to the embodiment of the present disclosure is spraying ink.

FIG. 3 is a conceptual diagram illustrating a case of moving a mask diagonally by using a mask transfer unit of the automatic spray apparatus including an airbrush and mask transfer mechanism according to the embodiment of the present disclosure.

FIG. 4 is a conceptual diagram illustrating a nozzle movement path in a case of moving a nozzle horizontally while the automatic spray apparatus including an airbrush and mask transfer mechanism according to the embodiment of the present disclosure is spraying ink.

FIG. 5 is a conceptual diagram illustrating a nozzle movement path in a case of moving the nozzle vertically while the automatic spray apparatus including an airbrush and mask transfer mechanism according to the embodiment of the present disclosure is spraying ink.

### MODE FOR INVENTION

Hereinafter, an exemplary embodiment of the present disclosure will be described in detail with reference to the accompanying drawings so that those skilled in the art in the technical field to which the present disclosure pertains can easily implement the present disclosure.

When explaining the embodiment, description of technical contents that is well known in the technical field to which the present disclosure belongs and that is not directly related to the present disclosure is omitted. This is intended to convey the gist of the present disclosure more clearly without obscuring the gist by omitting unnecessary explanations.

For the same reason, some components are exaggerated, omitted, or schematically illustrated in the accompanying drawings. In addition, the size of each component does not entirely reflect an actual size thereof. In each drawing, identical or corresponding components are assigned the same reference numbers.

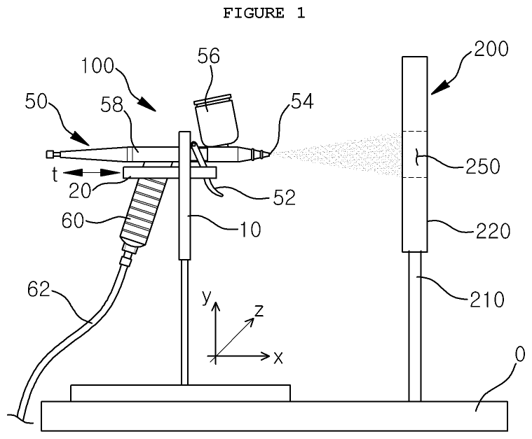

FIG. 1 is a side view generally illustrating how ink is sprayed by using an automatic spray apparatus including an airbrush transfer mechanism according to the embodiment of the present disclosure.

Referring to FIG. 1, the automatic spray apparatus including an airbrush and mask transfer mechanism according to the exemplary embodiment of the present disclosure includes an airbrush 50 for spraying liquid through a nozzle by using air supplied thereto, an airbrush transfer unit 100 capable of adjusting a relative distance from the airbrush 50 to a liquid spray target while supporting the airbrush 50, a mask 220 having a hole formed in a shape in which the liquid is applied on a surface of the liquid spray target, and a mask transfer unit 200 installed between the nozzle 54 of the airbrush 50 and the liquid spray target while supporting the mask, wherein the airbrush transfer unit 100 includes a trigger actuator 20 capable of operating a trigger 52 that controls the spraying of the liquid contained in a part of the airbrush 50.

The automatic spray apparatus including an airbrush and mask transfer mechanism according to the embodiment of the present disclosure includes the above components, and a detailed description of each of the components is as follows.

The airbrush 50 is a component configured to receive air through an air hose 62 connected to an end part of a grip 60, and to spray liquid, such as paints, coatings, and pigments, to the surface of the spray target through the nozzle 54 by using the received air so that the liquid is applied on the corresponding surface. The spraying work is usually performed with a predetermined amount of the liquid contained in a paint cup 56.

In this case, depending on an embodiment, the liquid may be continuously supplied by connecting a hose rather than the paint cup 56, and this liquid supply method is selected when a liquid application area is large.

An airbrush fixer 10 may be physically modified to fix the airbrush 50 with various types of grips and triggers, etc.

The airbrush transfer unit 100 is a component that

enables the position of the airbrush 50 to be adjusted according to a working condition while supporting and fixing the airbrush 50 at a predetermined height. Here, the position adjustment is possible in up and down directions (a y-axis direction), left and right directions (an x-axis direction), and a liquid spray direction (a z-axis direction) relative to a direction in which the airbrush 50 is placed. The x, y, z-axis directions refer to the axis-directions of a three-dimensional orthogonal coordinate system.

In addition, the airbrush transfer unit 100 includes the trigger actuator 20 capable of operating the trigger 52 of the airbrush 50, wherein the trigger actuator can move in the left and right directions relative to the direction of the drawing, which is indicated by an arrow t parallel to the z-axis direction.

The mask transfer unit 200 is a component configured to mount the mask 220 including a pattern hole 250, which is a hole formed in a corresponding shape (and a pattern), on a mask mount 210 and to locate the mask 220 between the nozzle 54 of the airbrush 50 and the spray target in order to settle liquid sprayed from the airbrush 50 on the surface of the spray target in a desired shape.

Here, the mask transfer unit 200 is generally implemented to maintain a predetermined position thereof in a fixed manner, but depending on implementation conditions and environments, is implemented so that the mask mount 210 of the mask transfer unit 200 is movable, so that the position of the mask 220 can be adjusted.

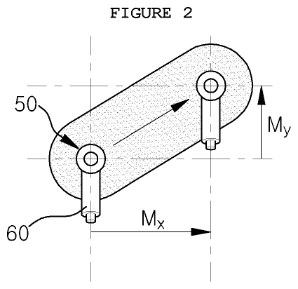

FIG. 2 is a conceptual diagram illustrating a case of moving the airbrush diagonally by using an airbrush transfer unit while the airbrush of the automatic spray apparatus including an airbrush and mask transfer mechanism according to the embodiment of the present disclosure is spraying ink.

Referring to FIG. 2, it can be seen that while the airbrush 50 is spraying ink, the airbrush 50 has been moved by Mx in the x-axis direction (left and right) and by My in the y-axis direction (up and down).

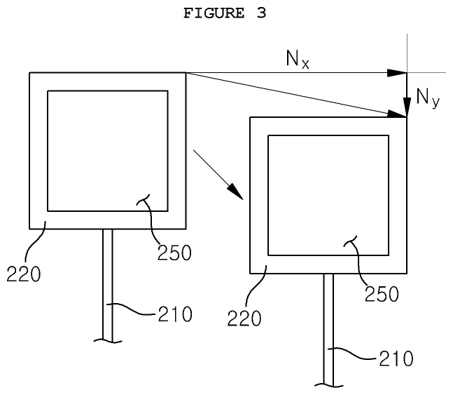

FIG. 3 is a conceptual diagram illustrating a case of moving the mask diagonally by using the mask transfer unit of the automatic spray apparatus including an airbrush and mask transfer mechanism according to the embodiment of the present disclosure.

Referring to FIG. 3, it can be seen that the mask 220 has been moved by Nx in the x-axis direction (left and right) and by Ny in the y-axis direction (up and down).

As illustrated in FIGS. 2 and 3, when moving the airbrush 50 by using the airbrush transfer unit 100 or when moving the mask 220 by using the mask transfer unit 200, in order to move the airbrush 50 or the mask 220 at a path and a speed desired by a user, a user interface device is installed on the automatic spray apparatus, and the user manipulates the surface of the user interface device so that the movement trajectory and speed of the airbrush transfer unit 100 or the mask transfer unit 200 desired by the user can be set.

Here, the user interface device transmits the input of the user to a control unit that controls the airbrush transfer unit 100 and the mask transfer unit 200, and the airbrush transfer unit 100 or the mask transfer unit 200 is moved at the desired trajectory and speed by the control unit.

In addition, the form of the user interface device may be a mechanical manipulation input device including a joystick, and a dial, etc., or a touch input device including a flat panel display, and may be implemented by selecting an appropriate form according to an embodiment.

In addition, there is an advantage that when the desired trajectory and speed of movement of the airbrush transfer unit 100 or the mask transfer unit 200 input by a user using the user interface device is stored in a memory device, the trajectory/speed settings input once can be repeatedly used.

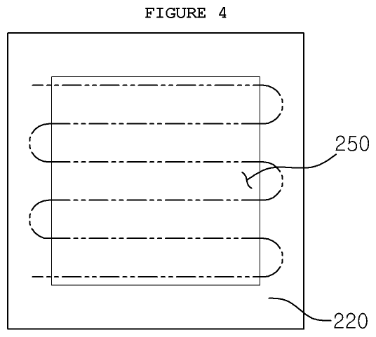

FIG. 4 is a conceptual diagram illustrating a nozzle movement path in a case of moving the nozzle horizontally while the automatic spray apparatus including an airbrush and mask transfer mechanism according to the embodiment of the present disclosure is spraying ink.

According to the exemplary embodiment of the present disclosure, when the automatic spray apparatus including an airbrush and mask transfer mechanism sprays liquid contained in the airbrush 50, the liquid passes through the pattern hole 250 engraved in the mask 220 and is applied in a desired shape on the surface of the spray target.

When the liquid contained in the airbrush 50 is sprayed, the liquid passes through the pattern hole 250 engraved in the mask 220 and is applied in a desired shape on the surface of the spray target.

In this case, in order to ensure that the liquid applied on the surface of the spray target has an even and consistent thickness, each of the airbrush 50 and the nozzle 54 of the airbrush 50 is slowly moved in a certain direction, and the direction is generally up and down or left and right directions. FIG. 4 shows an example of movement in the left and right directions.

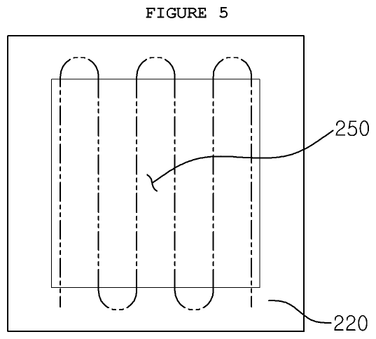

FIG. 5 is a conceptual diagram illustrating a nozzle movement path in a case of moving the nozzle vertically while the automatic spray apparatus including an airbrush and mask transfer mechanism according to the embodiment of the present disclosure is spraying ink.

According to the exemplary embodiment of the present disclosure, when the automatic spray apparatus including an airbrush and mask transfer mechanism sprays liquid contained in the airbrush 50, the liquid passes through the pattern hole 250 engraved in the mask 220 and is applied in a desired shape on the surface of the spray target.

When the liquid contained in the airbrush 50 is sprayed, the liquid passes through the pattern hole 250 engraved in the mask 220 and is applied in a desired shape on the surface of the spray target.

In this case, in order to ensure that the liquid applied on the surface of the spray target has an even and consistent thickness, each of the airbrush 50 and the nozzle 54 of the airbrush 50 is slowly moved in a certain direction, and the direction is generally up and down or left and right directions. FIG. 5 shows an example of movement in up and down directions.

When spraying liquid through the nozzle of the airbrush 50 as described above, it is common to move the airbrush 50 slowly, but a direction in which the airbrush 50 moves may be freely determined depending on each situation or implementation environment.

In addition, when moving the airbrush up and down, an order moving from a lower side to an upper side or from the upper side to the lower side does not affect the technical idea of the present disclosure and may be freely selected depending on an embodiment, and this also applies to left and right movement.

In addition, according to the exemplary embodiment of the present disclosure, a control unit in the form of a microchip including a control algorithm or a communication unit that enables remote control is added to the automatic spray apparatus including an airbrush and mask transfer mechanism, and it is possible to control the liquid spray/application time of the airbrush 50 through a remote control unit in wireless communication with the control unit or the communication unit.

In the case of the embodiment including the control unit or the communication unit as described above, it is possible to automatically control the positioning trajectory of the airbrush 50 to form a specific shape while the airbrush 50 is spraying/applying liquid.

In addition, it is possible to set a control algorithm so as to automatically perform an operation including the time and amount of spraying/application of liquid while the airbrush 50 is positioned and moved, and the number of times at which the positioning trajectory of the airbrush 50 is repeatedly controlled to form a specific shape while spraying the liquid, etc.

Meanwhile, the present specification and the drawings disclose the exemplary embodiment of the present disclosure, and although specific terms are used, the terms are used in a general sense to easily explain the technical content of the present disclosure and aid understanding of the present disclosure, but are not intended to limit the scope of the present disclosure. It is obvious to those skilled in the art that other modifications based on the technical idea of the present disclosure in addition to the embodiment disclosed herein can be implemented.

### DESCRIPTION OF THE REFERENCE NUMERALS IN THE DRAWINGS

10: Airbrush fixer
20: Trigger actuator
50: Airbrush
52: Trigger
54: Nozzle
56: Paint cup
58: Body
60: Grip
62: Air hose
100: Airbrush transfer unit
200: Mask transfer unit
210: Mask mount
220: Mask
250: Pattern hole

1. An automatic spray apparatus comprising an airbrush and mask transfer mechanism to spray liquid, the automatic spray apparatus comprising:
an airbrush for spraying liquid through a nozzle by using air supplied thereto;
an airbrush transfer unit capable of adjusting a relative distance from the airbrush to a liquid spray target while supporting the airbrush;
a mask having a hole formed in a shape in which the liquid is applied on a surface of the liquid spray target; and
a mask transfer unit installed between the nozzle of the airbrush and the liquid spray target while supporting the mask,
wherein the airbrush transfer unit comprises a trigger actuator capable of operating a trigger that controls the spraying of the liquid contained in a part of the airbrush.

2. The automatic spray apparatus of claim 1, wherein the airbrush transfer unit comprises a driving device such as a motor that enables a position of the airbrush to be adjusted up, down, left, right, forward, and rearward.

3. The automatic spray apparatus of claim 1, wherein the mask transfer unit comprises a driving device such as a motor that enables a position of the mask to be adjusted up, down, left, right, forward, and rearward.

4. The automatic spray apparatus of claim 1, wherein the automatic spray apparatus comprises a user interface device that is capable of being directly manipulated by a user,
wherein the user is capable of inputting a trajectory and a speed at which the airbrush transfer unit or the mask transfer unit is desired to be moved by manipulating a specific part on a surface of the user interface device, and
the user interface device transmits the input of the user to a control unit that controls the airbrush transfer unit and the mask transfer unit so that the airbrush transfer unit or the mask transfer unit is moved at the desired trajectory and speed through the control unit.

5. The automatic spray apparatus of claim 2, wherein the automatic spray apparatus comprises a user interface device that is capable of being directly manipulated by a user,
wherein the user is capable of inputting a trajectory and a speed at which the airbrush transfer unit or the mask transfer unit is desired to be moved by manipulating a specific part on a surface of the user interface device, and
the user interface device transmits the input of the user to a control unit that controls the airbrush transfer unit and the mask transfer unit so that the airbrush transfer unit or the mask transfer unit is moved at the desired trajectory and speed through the control unit.

6. The automatic spray apparatus of claim 3, wherein the automatic spray apparatus comprises a user interface device that is capable of being directly manipulated by a user,
wherein the user is capable of inputting a trajectory and a speed at which the airbrush transfer unit or the mask transfer unit is desired to be moved by manipulating a specific part on a surface of the user interface device, and
the user interface device transmits the input of the user to a control unit that controls the airbrush transfer unit and the mask transfer unit so that the airbrush transfer unit or the mask transfer unit is moved at the desired trajectory and speed through the control unit.
